(19) United States
(12) Patent Application Publication
(10) Pub. No.: US 2025/0367744 A1
(43) Pub. Date: Dec. 4, 2025

(54) OXY-FUEL WELDING AND CUTTING SYSTEM AND METHOD OF OPERATING THE SYSTEM

(71) Applicants: Christian Karl Peter ROHLSSEN, Johannesburg (ZA); Messer Cutting Systems GmbH, Gross-Umstadt (DE)

(72) Inventors: Karl Peter ROHLSSEN, Johannesburg (ZA); Axel VOGELSANG, Gross-Umstadt (DE)

(73) Assignees: Christian Karl Peter ROHLSSEN, Johannesburg (ZA); Messer Cutting Systems GmbH, Gross-Umstadt (DE)

(21) Appl. No.: 18/875,818

(22) PCT Filed: Jun. 26, 2023
(86) PCT No.: PCT/IB2023/056580

§ 371 Date: Dec. 17, 2024

(30) Foreign Application Priority Data
Jun. 27, 2022 (ZA) 2022/07073
Oct. 17, 2022 (EP) 22201904.4

(51) Int. Cl. B23K 5/22; B23K 7/10

(52) U.S. Cl. CPC B23K 5/22; B23K 7/10

(57) ABSTRACT

An oxy-fuel system for supplying a torch with a fuel gas stored under pressure in a container includes the following components: (a) an upstream fuel gas supply line between the container and the torch; (b) a demand valve arranged in the upstream fuel gas supply line; (c) the torch connected to an oxygen supply line. The torch includes a venturi nozzle adapted to generate in the upstream fuel gas supply line a negative pressure P_{negative} of at least −0.3 bar relative to atmospheric pressure in operating condition, and the demand valve is vacuum-controlled and configured to have a pressure setpoint to open the demand valve, the pressure setpoint being negative relative to atmospheric pressure and equal or less negative than P_{negative}.

### FIELD OF THE INVENTION

This invention relates to an oxy-fuel system. In particular, the invention relates to a system for supplying a torch with a fuel gas stored under pressure in a container, wherein a fuel gas withdrawal line leads from the container to the torch, in which at least one gas demand valve is located.

### BACKGROUND TO THE INVENTION

As known in the industry, oxy-fuel welding, brazing, heating and cutting are processes that use fuel gases and oxygen.

The equipment used in oxy-fuel welding, brazing, heating, and cutting requires an oxygen source and a fuel gas source (usually contained in cylinders), two pressure regulators, two flexible hoses (one for each source of gas), a torch and where mandatory a flashback arrestor. This set up may also be used for soldering and brazing.

The regulator ensures that pressure of the gas from the cylinders may be set in accordance to EN-ISO: 2503 The volume required for the task to be performed is then adjusted by the operator turning needle valves at the torch. Accurate flow control with a needle valve relies on a constant supply pressure from the regulator to the torch.

The hoses are manufactured to be compatible to the gases used. A doublehose or twinned design hose is sometimes used, meaning that the oxygen and fuel hoses are joined. However, beads of molten metal given off by the cutting process can become lodged between the hoses, and burn through, releasing the pressurised gas inside, which in the case of fuel gas usually ignites.

Fuel gas such as acetylene is not just flammable; in certain conditions it is explosive. Although it has an upper flammability limit in air of 81%, acetylene's explosive decomposition behaviour makes this irrelevant. If a detonation/deflagration wave enters the acetylene cylinder, the cylinder may be blown apart by the subsequent decomposition. Ordinary check valves/non-return valves that normally prevent backflow/reverse flow are not capable to stop a flashback as they do not contain flame quenching components.

Between the regulator and hose, and ideally between hose and torch on both oxygen and fuel lines, a flashback arrestor and/or non-return valve (check valve) may be installed to prevent flame or oxygen-fuel mixture being pushed back into either regulator at the cylinder and damaging the equipment or causing a cylinder to explode. A check valve lets gas flow in one direction only. It is usually a chamber containing a ball that is pressed against one end by a spring. Gas flow one way pushes the ball out of the way, and a lack of flow or a reverse flow allows the spring to push the ball into the inlet, blocking it.

The torch is the tool that the operator uses to perform the appropriate tasks required. It has a connection and valve for the fuel gas and a connection and valve for the oxygen, a handle for the welder to grasp, and gas mixing facilities where the fuel gas and oxygen mix, with a nozzle where the flame exits Two basic types of torches are in use; (i) nozzle mixing torches and (ii) premix-injector type torches.

Acetylene, LPG and other fuel gases are highly flammable, and form explosive mixtures with the surrounding air and/or oxygen. A major cause of accidents with gas equipment is leaking connections or poorly maintained equipment and the subsequent ignition of the leaking fuel gas which is extremely flammable can create an explosion. Even small leaks can cause a flash fire or explosion, particularly when the equipment is used in poorly ventilated areas or confined spaces such as in underground mining operations where the gases can accumulate. During the operations, sparks and spatter can be generated which are a major cause for ignition.

To detect leaks in the hoses or connections, leak detection spray is applied to all fuel gas and oxygen connections starting at the cylinder valve, regulator including all other connections up to the torch nozzle. It is especially user unfriendly when an entire length of hose needs to be sprayed and checked. Leaks will be clearly indicated by foaming bubbles at the point of leakage. A user will then know that it would be dangerous to light the gases at the nozzle and/or gas system before the leak is stopped or the leaking component is replaced.

This could be quite hazardous as a lot of this gas equipment is used underground or in confined spaces and the risk of explosions and the effect thereof can be devastating.

### OBJECT OF THE INVENTION

It is an object of this invention to provide an oxy-fuel system which, at least partially, alleviates some of the above-mentioned hazards.

In particular, it is the object of the invention to improve the known gas supply systems with respect to the safety standard.

In addition, it is a task to specify a method that allows the torch to be supplied with overstoichiometric fuel gas without having to compromise the safety of the system.

### SUMMARY OF THE INVENTION

In accordance with this invention there is provided for an oxy-fuel system comprising:
a fuel gas supply;
a vacuum controlled demand valve;
a cutting torch which creates a strong enough venturi to allow flow through the vacuum demand valve.

The oxy-fuel system wherein the components are in fluid connection in a series of fuel gas supply, vacuum-controlled demand valve, cutting torch.

Especially, the oxy-fuel system of the invention is designated for supplying a torch with a fuel gas stored under pressure in a container, and said system comprises the following components:
(a) a upstream fuel gas supply line between the container and the torch;
(b) a demand valve arranged in the upstream fuel gas supply line;
(c) the torch connected to an oxygen supply line,
wherein the torch comprises a venturi nozzle adapted to generate in the upstream fuel gas supply line a negative pressure P_{negative} of at least −0.3 bar relative to atmospheric pressure in operating condition, and wherein the demand valve is vacuum-controlled and configured to have a pressure setpoint to open the demand valve, said pressure setpoint being negative relative to atmospheric pressure and equal or less negative than P_{negative}

Due to the Venturi effect, the oxygen flow exiting the injector creates an effective negative pressure P_{negative} in the upstream fuel gas supply line. The decisive factor for the Venturi effect is the effective negative pressure P_{negative} present in the upstream fuel gas supply line.

The improved demand valve or “demand valve” matching the improved torch is vacuum controlled and configured to have a pressure setpoint which pressure must be reached to open the valve, wherein said pressure setpoint is negative relative to atmospheric pressure and equal or less negative than P_{negative}

If there is a leak in the upstream fuel gas supply line between the demand valve and the mixing nozzle inlet, this setpoint cannot be reached because of the fuel gas escaping there, so the demand valve will not open. The same applies if there is a leak in the oxygen line so that the Venturi effect is not sufficient to set the negative pressure setpoint or if one of the two lines mentioned is blocked.

The effective negative pressure P_{negative} is defined as the pressure measured in the upstream fuel gas supply line when the torch is in its operating mode. That means, a nozzle is inserted in the outlet path for the oxygen fuel gas mixture, e.g. a cutting, welding or heating nozzle is inserted in the torch head. The effective negative pressure P_{negative} must be reached regardless of the specific nozzle currently used. In the idle state, that means, when no nozzle is inserted in the outlet path for the fuel gas mixture, the negative pressure difference must be even higher (more negative relative to atmospheric pressure) than the effective negative pressure P_{negative}. The values given for P_{negative} are always differential pressures relative to atmospheric pressure (i.e. 1 bar), regardless of whether they are preceded by a minus sign or not. A higher value for P_{negative} means a larger difference to 1 bar, i.e. a lower absolute pressure. In this sense, for example, −0.4 bar is a “higher value” than-0.3 bar.

The invention essentially differs from the current state of the art of the torch mixer in that, on the one hand, it fulfills the requirements of DIN EN 5175, but in addition generates a defined negative difference pressures relative to atmospheric pressure (1 bar) higher than −0.3 bar. This high negative pressure makes it possible to open the corresponding vacuum controlled demand valve (e.g. a so called S.A.T. valve-Safety Advanced Technology) and is able to deliver the required amount of fuel gas in order to optimally adjust the flame and can thus also generate a fuel gas surplus.

For the demand valve to open, its pressure setpoint must be equal or lower (i.e. less negative) than the effective negative pressure P_{negative} generated by the injector torch. On the other hand, the higher the negative pressure generated by the injector torch, the greater the suction effect and the more sensitive the leak detection. It is therefore preferred that the pressure setpoint to open the demand valve is at least −2.5 bar, preferably at least −3 bar and most preferred at least −4 bar relative to atmospheric pressure.

The invention optimizes the injector as well as the demand valve.

The demand valve comprises: a valve body having an operatively upper and lower sections secured with securing means, a flow path therethrough, a flow path closure member and a diaphragm to move the closure member from a closed position to an open position in case of a pressure difference across the diaphragm.

It is preferred that the demand valve is a diaphragm valve (or membrane valve) comprising
(a) a valve body with a first port connected to the container, and a second port connected to the upstream fuel gas supply line,
(b) a diaphragm clamped in the valve body,
(c) a closure member coupled to the first side of the diaphragm and cooperating with a valve seat located between a valve inlet and a valve outlet, said closure member is adapted to open a passage between the valve inlet and the valve outlet when the pressure on the second side of the diaphragm is equal or higher (more negative relative to atmospheric pressure) than the pressure setpoint.

Such diaphragm valves are simple and robust in design and they work reliably.

Particularly with regard to the realization of a pressure setpoint as high as possible, it has proven valuable if the diaphragm has a circular cross-section with a diameter D_{M}, wherein D_{M} is greater than 50 mm, preferably greater than 52 mm, and particularly preferably greater than 54 mm.

The large size of the diaphragm is particularly noticeable when the valve outlet opening dᵥ is relatively small. This is because the greater the D_{M}/dᵥ ratio, the greater the flow rate of fuel gas can be for the same suction power. Or, to express it another way, by a higher ratio it is easier to set a fuel gas surplus in the fuel gas/oxygen mixture without the suction capacity dropping too far.

With regard to this, an embodiment is preferred in which the valve seat forms a valve opening with an inner diameter dᵥ, and that the diameter ratio D_{M}/dᵥ is greater than 8.5, preferably greater than 8.8, and most preferred greater than 9.1.

The torch which is most suitable for the oxy-fuel system is preferably an injector torch comprising a torch base body, a torch head connected to the torch base body and a torch tip held therein, wherein flow paths are defined in the torch base body, at least one of which is a upstream fuel gas supply line extending from a fuel gas inlet, and at least one other being an oxygen path extending from an oxygen inlet, and wherein the upstream fuel gas supply line and at least a conduit portion of the oxygen path join at a venturi nozzle to form a common outlet path leading through the torch tip,
wherein the venturi nozzle comprises a pressure nozzle fluidically connected to the oxygen line and having a nozzle outlet,
wherein the outlet path comprises a mixing nozzle and a mixing nozzle inlet for generating an oxygen-fuel gas mixture,
and wherein the venturi nozzle and the mixing nozzle are adapted to generate the negative pressure P_{negative} of at least −0.3 bar relative to atmospheric pressure in operating mode.

In so-called “injector torches”, the oxygen is supplied at a higher pressure than the fuel gas. The oxygen flowing into the injector creates a negative pressure, as a result of which the fuel gas is sucked in and entrained. Oxygen and fuel gas mix in the mixing tube. In the case of state-of-the-art autogenous systems, this negative pressure is not defined, but only the overall system must meet the requirements of DIN EN ISO 5172 in order to permit a corresponding approval. In order to ensure that a negative pressure is established in the injector torch, this DIN standard prescribes the performance of a “suction test”. The “suction test” is still considered to have been passed if the pressure measured on the fuel gas side does not exceed 0.5 times the fuel gas pressure specified by the manufacturer. That means, that this condition is also fulfilled if the pressure on the fuel gas side is above atmospheric pressure, i.e. the pressure in the fuel gas line is greater than zero; this is not a “negative pressure” in the sense that the pressure is below atmospheric pressure. Nonetheless, the inventors have measured the pressure in the fuel gas line of injector torches available on the market. They found that they usually have a negative pressure at the fuel gas connection of 0.05 to 0.2 bar (this means an absolute pressure of 0.8 to 0.95 bar).

But this reduced pressure is, on the one hand, not exactly defined and may also fluctuate into the positive pressure range as process conditions or torch designs change, and, on the other hand, the pressure, although reduced, may not be low enough to detect a (small) pressure change caused as a result of a (small) leak if it is not sufficient to cause reliable closing of the connected demand valve.

That is, one of the merits of the invention is to have recognized that the “negative pressure” in prior art systems was undefined and too low for reproducible functionality. This means that the core of the invention is the generation of the defined negative pressure in order to ensure the function of the overall system in conjunction with the negative pressure valve and thus to produce an absolutely leakage-free and safe system. The fulfilment condition of ISO 5172 2 are thus also fulfilled, but do not represent the main focus.

The torch creates a sufficient venturi effect to ensure the opening of a demand valve in an upstream fuel line. Upon breach of the fuel line, the demand valve will close rendering the torch and connected system safe.

The invention also optimizes the injector, mainly pressure and mixing nozzle in their ratio and dimensions so, that for the first time an appropriately defined negative pressure difference >0.3 bar can be generated in the fuel gas supply line.

The suction effect at the fuel gas connection, which is achieved by the venturi effect, serves primarily to provide safety against gas backflow into the fuel gas line under all operating conditions for the corresponding torch or application.

The Venturi nozzle and the mixing nozzle are preferably designed so that an effective negative pressure P_{negative} of at least −0.4 bar, preferably in the range of −0.4 to −0.8 bar, and particularly preferably in the range of −0.42 to −0.6 bar relative to atmospheric pressure can be set in the upstream fuel gas supply line.

The higher the range lower limit is selected, the more sensitive the leak detection responds; but the more difficult and costly it is to set the negative pressure setpoint reproducibly. Therefore, negative pressure set points higher than −0.8 bar are technically feasible but not preferred in practice.

There are several design and process parameters for adjusting the negative pressure setpoint. A particularly preferred design parameter is that a distance A in the range between 0.2 mm and 2 mm, preferably between 0.25 mm and 1.5 mm and especially preferably between 0.3 mm and 1.2 mm is set between the nozzle outlet of the pressure nozzle and the mixing nozzle inlet.

If the distance A is too narrow, the oxygen flow exiting the narrow pressure nozzle outlet can impede the inflow of the fuel gas. If the distance A is too large, the oxygen flow upstream of the mixing nozzle inlet may fan out to such an extent that it mixes noticeably with the fuel gas even before the mixing nozzle inlet and the setpoint for the effective negative pressure P_{negative} in the upstream fuel gas supply line is not achieved.

Another preferred design measure for achieving a sufficient Venturi effect is that the mixing nozzle inlet has a diameter D, and that the nozzle outlet of the pressure nozzle has a diameter d, and that the following applies for the diameter ratio d/D: 0.1<d/D<0.8, preferably 0.15<d/D<0.5, particularly preferably 0.2<d/D<0.4.

At a very small diameter ratio d/D of less than 0.1, the flow rate of oxygen is low and thus the amount of fuel gas and the power of the torch are also low. With a very large diameter ratio d/D of more than 0.8, the Venturi effect and thus the suction power becomes smaller and smaller.

It has proved useful if the venturi nozzle comprises at least one injector insert in which or on which a fuel gas chamber is formed which is fluidically connected to the upstream fuel gas supply line and is adjacent to the mixing nozzle inlet, the nozzle outlet of the pressure nozzle being opposite the mixing nozzle inlet.

The at least one injector insert is inserted, for example, into the torch base body or into the torch head. It contains at least one channel and/or cavity for the inflowing oxygen stream. It also contains at least one channel and/or cavity for the inflowing fuel gas, or it forms the at least one channel and/or cavity for the fuel gas together with the surrounding torch base body or torch head.

The nozzle outlet of the pressure nozzle communicates with the fuel gas chamber, for example, by being adjacent to the fuel gas chamber. The oxygen flow exiting the pressure nozzle outlet and entering the opposite mixing nozzle inlet passes through the combustion gas chamber, generates the effective negative pressure P_{negative} there due to the Venturi effect and entrains fuel gas into the opposite mixing nozzle.

In the diagram in FIG. 7, the oxygen pressure at the inlet of the pressure nozzle (in bar) is plotted against the outlet pressure (in bar) at the oxygen pressure regulator for a cutting torch without a cutting nozzle as well as for different cutting nozzle sizes inserted therein (the numbers in columns 4 to 9 indicate the thickness range of the metal sheets for which the cutting nozzle is designed).

Table 1 shows the measured values on which the diagrams of FIG. 7 and of FIG. 8 are based.

TABLE 1

| | | | Pressure at | | Pressure at | | Pressure at | |
|---|---|---|---|---|---|---|---|---|
| | Pressure at | Negative | pressure | Negative | pressure | Negative | pressure | Negative |
| Pressure | pressure nozzle | pressure | nozzle | pressure | nozzle | pressure | nozzle | pressure |
| at the | [bar] | [bar] | [bar] | [bar] | [bar] | [bar] | [bar] | [bar] |
| pressure | without | without | Cutting | Cutting | Cutting | Cutting | Cutting | Cutting |
| regulator | Cutting | Cutting | nozzle | nozzle | nozzle | nozzle | nozzle | nozzle |
| [bar] | nozzle | nozzle | 3-10 | 3-10 | 10-100 | 10-100 | 100-300 | 100-300 |
| 1 | 0.7 | −0.13 | 0.6 | −0.1 | 0.6 | −0.1 | 0.5 | −0.1 |
| 2 | 1.5 | −0.22 | 1.5 | −0.15 | 1.5 | −0.16 | 1.5 | −0.19 |
| 3 | 2.4 | −0.26 | 2.4 | −0.21 | 2.4 | −0.23 | 2.4 | −0.26 |
| 4 | 3.3 | −0.37 | 3.3 | −0.3 | 3.2 | −0.3 | 3.2 | −0.34 |
| 5 | 4.1 | −0.44 | | | 4.1 | −0.36 | 4.2 | −0.42 |
| 6 | 5.0 | −0.5 | | | 5.0 | −0.4 | 5.0 | −0.49 |
| 7 | 5.9 | −0.56 | | | | | 5.8 | −0.56 |
| 8 | 6.7 | −0.61 | | | | | 6.7 | −0.6 |
| 9 | 7.6 | −0.69 | | | | | 7.6 | −0.65 |
| 10 | 8.5 | −0.72 | | | | | 8.5 | −0.69 |

It can be seen that the pressure drop is essentially independent of the type of cutting nozzle used, and that the pressure at the pressure nozzle scales with the pressure at the pressure regulator.

With regard to the method of operating the torch according to the invention, the above technical problem is solved according to the invention by a method comprising the following method steps:
a fuel gas is supplied to the torch via an upstream fuel gas supply line with a nominal fuel gas pressure P_{H2} in the range of 0.5 to 2 bar,
oxygen is supplied to the torch via an oxygen line with an oxygen nominal pressure P_{O2} in the range of 2 to 10 bar,
the torch is provided with a venturi nozzle, which is designed so that an effective negative pressure P_{negative} of at least −0.3 bar relative to atmospheric pressure in operating condition is set in the fuel gas supply line,
wherein the demand valve is vacuum-controlled and configured to have a pressure setpoint to open the demand valve, wherein said pressure setpoint is negative relative to atmospheric pressure and equal or less negative than P_{negative}.

The venturi nozzle is designed such that a negative pressure P_{negative} of at least −0.3 bar relative to atmospheric pressure is set in the upstream fuel gas supply line.

Due to the Venturi effect, the oxygen flow leaving the outlet of the pressure nozzle and entering the mixing nozzle inlet creates an effective negative pressure P_{negative} in the upstream fuel gas supply line. This continues throughout the fuel gas supply line to the shut-of-valve (demand valve). The demand valve is vacuum-controlled and opens only when the negative pressure P_{negative} in the upstream fuel gas supply line has reached the pressure setpoint which is equal or less negative than the effective negative pressure P_{negative}.

The system of burner and demand valve is adjusted to each other in such a way that the demand valve is opened only when sufficient oxygen flows through the burner to generate the minimum negative pressure, so that the fuel gas can then also flow. Without oxygen flow, there is also no fuel gas flow.

If there is a leak in the upstream fuel gas supply line between the demand valve and torch, the pressure setpoint cannot be reached because of the fuel gas escaping there, so the demand valve will not open. The same applies if there is a leak in the oxygen line so that the Venturi effect is not sufficient to set the negative pressure setpoint or if one of the two lines mentioned is clogged.

In a particularly preferred process variant, a negative pressure P_{negative} of at least −0.4 bar, preferably in the range of −0.4 to −0.8 bar, preferably in the range of −0.42 to −0.6 bar relative to atmospheric pressure is set in the upstream fuel gas supply line, and in that the pressure setpoint to open the demand valve is at least −2.5 bar, preferably at least −3 bar and most preferred at least −4 bar relative to atmospheric pressure.

The oxy-fuel welding and cutting system wherein the fuel gas supply is acetylene, however the invention is not limited in this regard and LPG, hydrogen, MPS and MAPP gas, propylene, butane, chemtane or any other appropriate fuel gas may be used.

In a preferred embodiment a fuel gas-oxygen mixture at or near the stoichiometric point, i.e., 35% acetylene and 65% oxygen or 82% oxygen and 18% LPG, or near other stoichiometric points is used.

The oxy-fuel system allows the operator to create a fuel/oxygen mixture at or near the stoichiometric point which is 35% acetylene and 65% oxygen, or 82% oxygen and 18% LPG or near such other stoichiometric points depending on other fuel gases used.

In another preferred embodiment, a fuel gas-oxygen mixture with a overstoichiometric fuel gas is used. For example, the excess fuel gas is at least 5% higher than the stoichiometric mixture, preferably at least 9%.

The oxy-fuel system wherein the vacuum demand valve is made from lightweight materials. Preferably the valve body and all its parts are made of Nylon-6® (also known as “Polyamid-6”).

The oxy-fuel system is a S.A.T. oxy-fuel system.

These and other features of the invention are described in more detail below.

### BRIEF DESCRIPTION OF THE DRAWINGS

One embodiment of the invention is described below, by way of example only, with reference to the drawings in which:

FIG. 1 shows an oxy-fuel system;

FIG. 2 shows the torch which forms part of the oxy-fuel system of FIG. 1;

FIG. 3 shows the valve which forms part of the oxy-fuel system of FIG. 1;

FIG. 4 shows the valve of FIG. 3 in a cross section;

FIG. 5 shows the valve of FIG. 3 in an exploded view;

FIG. 6 shows the torch head of the torch of FIG. 2 in a cross section;

FIG. 7 a diagram explaining the relationship between the oxygen pressure set at the pressure regulator and the pressure applied to the pressure nozzle,

FIG. 8 a diagram explaining the relationship between the oxygen pressure set at the pressure regulator and the suction pressure applied in the upstream fuel gas supply line, and

FIG. 9 a three-dimensional representation of a longitudinal injector integrated in a torch head, partially in section.

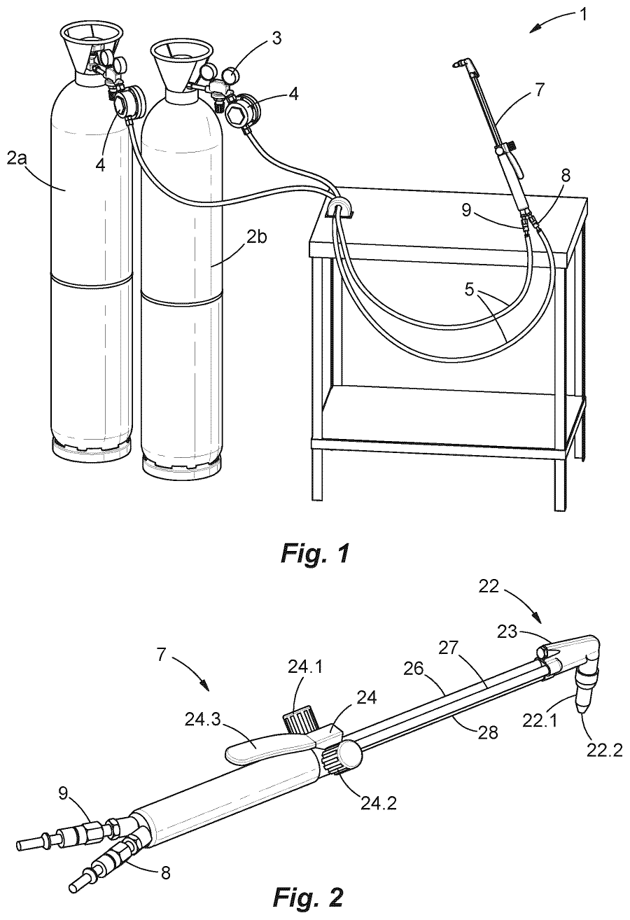

### DETAILED DESCRIPTION OF THE DRAWINGS

With reference to the drawings, an oxy-fuel system is generally depicted by reference numeral 1.

The oxy-fuel system is a S.A.T oxy-fuel system (S.A.T—Safety Advanced Technology) which makes use of gas and not liquid. The oxy-fuel system 1 makes use of an oxy-fuel gas supply 2. The fuel supply 2b is in this instance an acetylene gas cylinder and has a conventional regulator 3.

The S.A.T. valve 4 is directly connected to the regulator 3 outlet.

The S.A.T. valve 4 is connected, via a hose 5 to a torch 7.

The fuel supply 2, regulator 3, S.A.T valve 4, hose 5, and torch 7 are all connected in line and in fluid communication with one another.

Gas flow paths in the torch 7 are designed to create a venturi when oxygen flows through the torch 7 from the oxygen inlet 9. This venturi creates a negative pressure that opens the S.A.T valve 4 which in turn allows sufficient amounts of fuel gas to flow via the hose 5 to the torch 7.

The S.A.T valve 4 has a diaphragm which is large enough that a venturi, created by the system, is strong enough to open the demand valve.

The S.A.T valve 4 contains the pressure of the fuel supply 2 and will allow for fuel to flow only when the torch 7 demands it.

If the flow of fuel through the hose 5 is interrupted, or the pressure inside the hose drops, the flow of fuel will be cut off from the tube 5 by the S.A.T valve 4. This interruption may be caused by a number of incidents, such as a joint between two components leaking, the hose 5 being broken, cut or damaged by sparks and spatter which can fly-off during operation, or the oxygen supply being cut off and thereby causing a drop in demand from the venturi.

The demand from the venturi is not only crucial to the safety of the system 1 but also assists in obtaining sufficient fuel gas such that the operator can achieve at or close to the stoichiometric point. This ratio is the ideal ratio for obtaining an optimised flame at a temperature of 3150° C. for acetylene

The fuel supply is not limited to using acetylene and any appropriate fuel, such as LPG, hydrogen, MPS and MAPP gas, propylene, butane, chemtane etc. may be used.

It is envisaged that incorporating the concept described herein to form part of all new oxy-fuel systems as it improves substantially the safety to the operator and equipment of such systems.

In the future oxy-fuel systems will incorporate this system is it not only ensures a more advantageous flame but also ensures the safety of the system as well as the user and the area in which the system is used.

This S.A.T system provides a significant improvement on the safety of currently used conventional systems in that this system does not allow for any gas to leak out of the system and as such will prevent any gas from being ignited by accident.

The torch 7 shown in FIG. 2 is an injector torch to create a heat source for heating, cutting, braising or welding. In the preferred example, it is designed as a cutting torch and comprises a torch head 2 with an injector 23 designed as a longitudinal injector, a base body 24 and a handle 25.

On the handle 25 there is a hose connection for oxygen 9, a hose connection 8 for the fuel gas (such as acetylene). The valves required for shutting off and regulating are usually located on the base body 4, namely a heating oxygen regulating valve 4.1, a fuel gas regulating valve 4.2 and a trigger arm 4.3 for setting the volume flow for the cutting oxygen. A cutting oxygen line 26 leads from the base body 24 to the torch head 22; and an upstream fuel gas supply line 27 and a line 28 for heating oxygen lead to the injector 23. A nozzle assembly is inserted into the torch head 22, comprising a heating nozzle 22.1 and a cutting nozzle 22.2. The base body 24 with the operating parts 24.1, 24.2 and 24.3 can be made in one piece with the handle 25 of the torch 7.

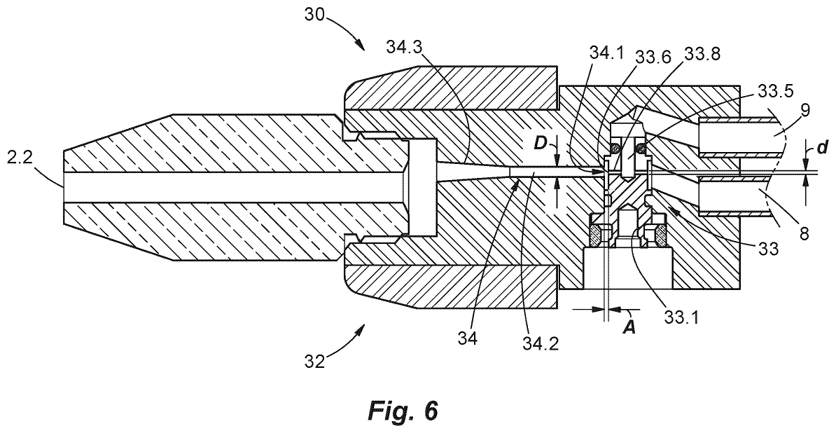

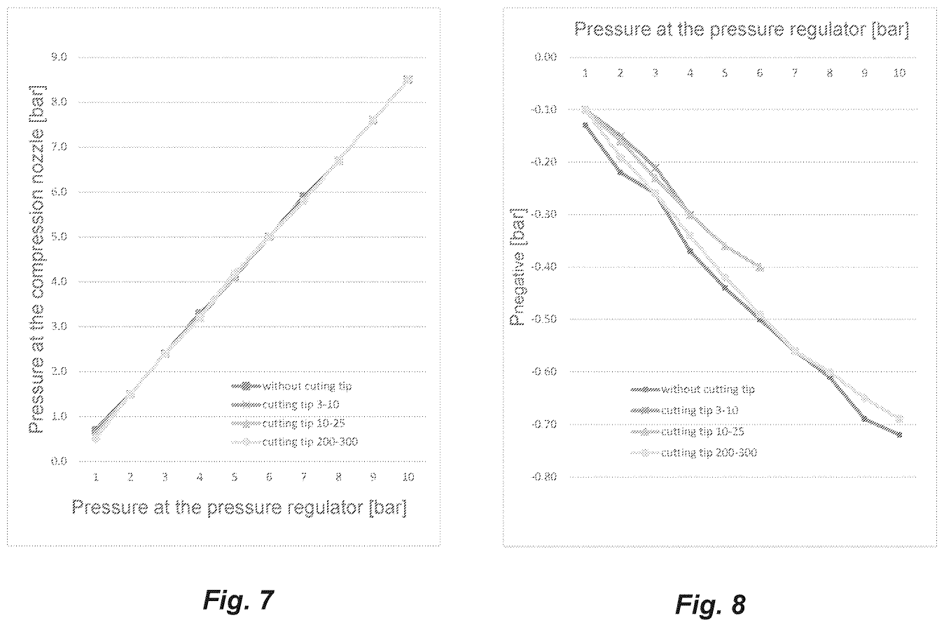

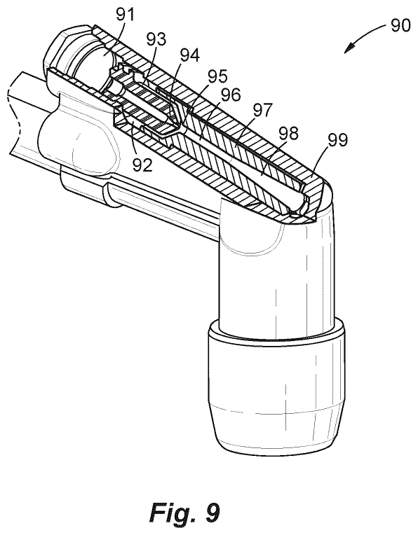

The injector 33 is suitable to create a Venturi effect, which is suitable to cause a pressure reduction in the fuel gas hose 5. For this purpose, the torch is operated so that the heating oxygen is supplied at a higher pressure than the fuel gas. The heating oxygen flowing into the injector creates a negative pressure, as a result of which the fuel gas is drawn in and entrained. Heating oxygen and fuel gas mix in a mixing tube (FIG. 6; FIG. 9) and flow out via the cutting nozzle 22.2.

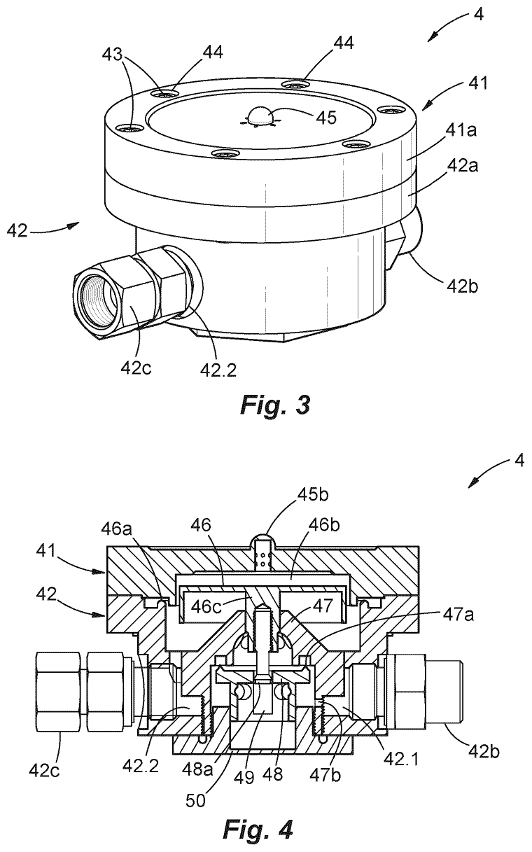

The demand valve 4 shown in FIG. 3 has a body defined by an upper cover 41 and lower cover 42. The upper cover 41 has a central hole 45. A flow path extends between an inlet opening 42.1 (FIG. 4) and an outlet opening 42.2. The flow path is selectively openable and closable as discussed further herein. An inlet nozzle 42b is screwed into a complementary screw-threaded inlet opening 42.1. An outlet nozzle 42c is similarly screwed into a screw-threaded outlet opening 42.2.

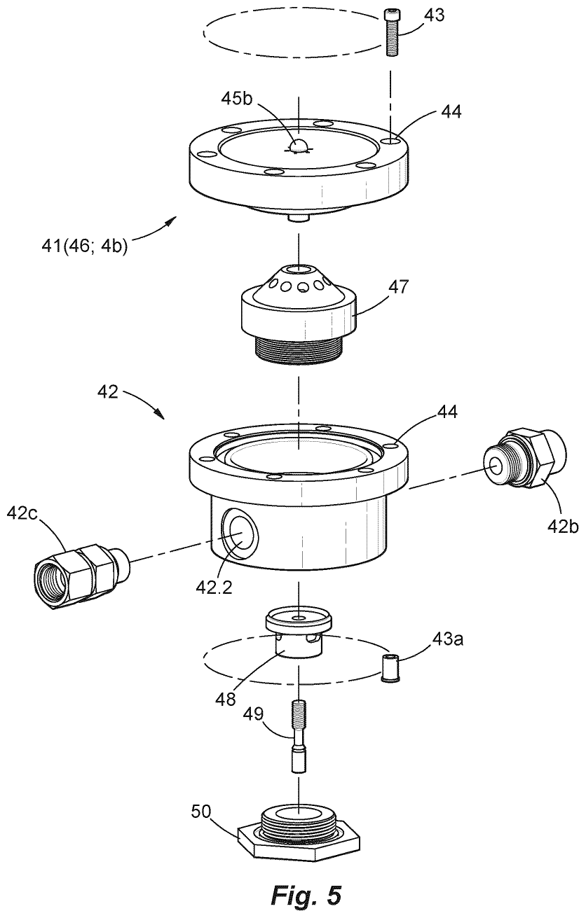

The two covers 41; 42 are securable together with press studs 43a (FIG. 5) and securing caps 43b. The press studs 43a extend through holes in aligned apertures 44a, 44b (FIG. 5) in the upper and lower covers (41; 42). The apertures 44a, 44b are spaced about circumferential flanges 41.4, 42.4 in of the upper cover 41 and in the lower cover 42 respectively.

In the following, the internal components of the valve 4 are explained with reference to FIG. 4 and to FIG. 5.

The inner, facing surfaces of the flanges receive a circumferential diaphragm 46 therebetween. A downwardly extending annular lip 46a on the flange of the diaphragm 46 seats in an annulus (a groove) in the upper surface of the lower cover 42. The diaphragm 46 spans the round opening 46b, which has a diameter of 54.7 mm. This corresponds to the effective diameter D_{M} of the diaphragm 46.

A breather nozzle 45b is situated centrally on an upper surface of the upper cover 41.

The nozzle 45b includes a breather hole.

A conically shaped diffuser 47 locates centrally in the lower cover 42 with its apex pointing operatively upwardly. The diffuser 47 has an upper, central aperture in its apex. Diffuser holes are provided in the conical part of the diffuser 47. The lower, widest edge of the conical section of the diffuser 47 terminates in a thickened cylindrical wall that sealingly secures in a complementary annular receiving formation in the lower part. The underside of the diffuser 47 terminates in a downwardly extending tubular section, which an outer screw thread.

A support cap 46b located underneath the diaphragm 46 is movable with the diaphragm 46. The support cap 46 has a central downward extending shank 46c. The shank 46c has a screw threaded blind bore in its lower end. The shank 46c is slidably and snugly moveable in the upper aperture of the diffuser 47.

A valve closure 48 has a short tubular part with a radially extending upper flange which includes an upwardly extending circumferential rim. The upper ridge of the rim forms an O-ring seat 47a. Apertures are provided in the tubular wall of the valve closure part 47.

An assembly pin 49 has an upper screw-threaded end and a lower thickened end. The pin 49 extends through a central bore 48a in the valve closure 48 and screws into the bore in the shank. The thickened end has a larger diameter than the bore 48a. This ensures that the pin 49, when under upward spring bias and assuming that the diaphragm is in rest, forces the valve closure 48, and specifically the rim of the closure, against an O-ring to close a flow path through the valve 4. In the position shown in FIG. 4 the flow path is closed. The diameter of the bore 48a is 5.9 mm. This corresponds to the diameter dᵥ of the valve seat.

A closure and securing cap 50 with a co-axial, raised and screw threaded annular rebate, screws into a lower complementary screw threaded bore of the lower part 42.

With the configuration of the valve 4 as described and shown, the valve is able to withstand 26 bar without leakage. This is specifically aided by the size of the tongue and groove or annulus that assist in securing the diaphragm 46 and the securing screws 43b to secure the main body parts 41; 42 of the valve together. The valve has a relatively large diaphragm 46 but is set to open at −0.4 bar when it is used in the oxy fuel welding and cutting system referred to above. In the event of even a minor leak in the fuel gas supply line 5, much less a rupture, the demand valve 4 will close, making the torch 7 and connected system safe.

The valve is made of nylon-6®. This has many advantages such as: there is a certain amount of memory in case of deformation of the valve body and valve parts, certainly more than is the case with prior art copper valves, it performs better and lasts longer with gasses such as acetylene and it is easier to manufacture especially considering that copper valves must have less than 70% pure copper content. Since the valve is made of nylon-6®, no galvanic corrosion occurs.

The off-centre breathing hole on the side of the breather nozzle or nipple is less likely to be contaminated, especially through manual manipulation of the valve. The diaphragm can also not be manipulated by forcing a wire or other elongate, substantially straight object through the breather hole to depress the diaphragm. The arduous path from the breathing hole to the diaphragm makes it almost impossible to manipulate the diaphragm with a physical object through the breathing hole.

FIG. 6 shows in longitudinal section a torch head 32 of an injector torch 30 which can be used in the oxy-fuel system according to the invention.

The torch head 32 is designed to produce sufficient venturi effect to ensure the opening of the vacuum-controlled demand valve in the upstream fuel supply line. The torch, on the one hand, fulfills the requirements of DIN EN 5175, but in addition generates a defined high negative pressure difference of at least −0.3 bar, preferably at least −0.4 bar, which makes it possible to open the negative pressure valve (the S.A.T. valve 4) and is able to deliver the required amount of fuel gas in order to optimally adjust the flame and can thus also generate a fuel gas surplus.

The invention optimizes the area of the injector, mainly pressure and mixing nozzle in their ratio and dimensions so, that for the first time an appropriately defined negative pressure difference of at least −0.3 bar, preferably at least −0.4 bar, can be generated in the fuel gas supply line.

The suction effect at the fuel gas connection, which is achieved by the venturi effect, serves primarily to provide safety against gas backflow into the fuel gas line under all operating conditions for the corresponding torch or application.

It is a key point of the invention that a defined negative pressure is generated in the fuel gas line in order to ensure the function of the overall system in conjunction with the negative pressure valve 4 and thus to produce an absolutely leakage-free and safe system.

The injector of FIG. 3 is designed as a longitudinal injector 33. A mixing nozzle 34 is formed in the torch head 32. An injector 33 is inserted between the mixing nozzle 34 and the oxygen and fuel gas paths (8; 9) opening into the torch head 32. Oxygen flows from the oxygen line 9 into a pressure nozzle 33.5 at a pressure of, for example, 2.5 bar (preferred range: 2 to 8.5 bar). The fuel gas flows from the fuel gas path 8 at a lower pressure of, for example, 1 bar (preferred range: 0.4 to 1.7 bar) into an annular fuel gas chamber 33.7, which is fluidically connected on the one hand to the pressure nozzle 33.5 via the narrow nozzle outlet 33.6 and on the other hand to the mixing nozzle 34. The pressure nozzle 33.5 (oxygen) opens into the annular fuel gas chamber 33.7 via a bore 33.8 with a narrow nozzle outlet 33.6. The oxygen flows at high pressure from the pressure nozzle 33.5 into the annular fuel gas chamber 33.7 and enters the opposite located mixing nozzle 34. The oxygen flow thus generates a negative pressure in the annular fuel gas chamber 33.7, so that the fuel gas is drawn from the fuel gas chamber 33.7 at an effective negative pressure P_{negative}, oxygen and fuel gas mix in the mixing nozzle 34 and the gas mixture enters the cutting nozzle 2.2 via a mixing channel 34.2 and adjoining settling area 34.3.

The effective negative pressure P_{negative} present in the annular fuel gas chamber 33.7 is at least −0.3 bar (under atmospheric pressure) according to the invention, preferably it is at least −0.4 bar and preferably in the range between −0.4 and −0.9 bar, particularly preferably between −0.42 and −8 bar. This effective negative pressure P_{negative} can be established-apart from a negligible pressure drop of the order of up to 10%-in the entire fuel gas path 8, up to the demand valve 4 inserted in the fuel gas path 8. The vacuum-controlled safety valve 4 is designed to open fuel gas path 8 only at a negative pressure of at least 0.3 bar for the fuel gas and to close it otherwise.

The effective negative pressure P_{negative} is determined to a large extent by the distance A between the outlet (nozzle outlet 33.6) of the narrow bore 33.8 and the nozzle inlet 34.1 of the mixing nozzle 34. This distance corresponds to the width of the annular fuel gas chamber 33.7. If the distance A is too narrow, the oxygen stream flowing out of the narrow nozzle outlet 33.6 can obstruct the entry of the fuel gas into the annular fuel gas chamber 33.7. If the distance A is too large, the oxygen flow may fan out too much upstream of the nozzle inlet 34.1 of the mixing nozzle 34, so that it already mixes appreciably with the fuel gas upstream of the mixing nozzle 34 and the setpoint for the effective negative pressure P_{negative} in the fuel gas path 8 is not reached. In the preferred example, the distance A is 0.65 mm.

Another design parameter that affects the effective negative pressure P_{negative} is the diameter ratio d/D between the diameter d the narrow pressure nozzle outlet 33.6 and the diameter D at the nozzle inlet 34.1 of the mixing nozzle 34. The diameter of the narrow nozzle outlet 33.6 is always smaller than the diameter D at the nozzle inlet 34.1 of the mixing nozzle 34, so that the diameter ratio d/D is smaller than 1. Particularly preferably, it is in the range between 0.1 and 0.8, preferably between 0.14 and 0.5, and most preferably in the range between 0.2 and 0.4. If the diameter ratio d/D is very small, e.g. less than 0.1, the flow rate of oxygen is low and thus the amount of fuel gas and the power of the torch are also low. With a large diameter ratio d/D, e.g. more than 0.8, the Venturi effect and thus the suction power becomes small so that there is a risk that the effective negative pressure P_{negative} cannot be generated and maintained in the fuel gas path. These above-mentioned diameter d/D ratios apply to typical pressure nozzle diameters in the range of 0.3 to 5 mm. If both d and D become equally smaller, the diameter ratio remains the same and the suction power increases, but a pressure nozzle diameter of less than 0.3 mm results in a low gas flow volume and thus a low torch performance.

In the preferred example, d is 0.57 mm and D is 1.9 mm, and the diameter ratio d/D is 0.3.

The partial sectional view of the cutting torch 90 of FIG. 9 serves to explain the injector principle using the example of a longitudinal injector insert inserted into the torch head. The following components can be identified:
91: inlet area of the heating oxygen
92: annular combustion gas chamber
93: pressure nozzle
94: pressure nozzle bore
95: mixing nozzle inlet. Here the negative pressure P_{negative} is present, which sucks in the fuel gas.
96: mixing nozzle
97: mixing channel (upstream section): Here, the oxygen flows in centrally at high velocity. This is how the negative pressure is created in the mixing nozzle inlet area
98: mixing channel (downstream area): Calming section-here the oxygen mixes further with the fuel gas
99: torch head: Mixing section of both gases

Under typical operating conditions, the torch can generate a negative pressure P_{negative} relative to atmospheric pressure of at least −0.3 bar, for example a negative pressure P_{negative} of −0.4 bar.

An example of an embodiment of the process according to the invention is explained in more detail below with reference to FIG. 3.

A cutting torch 30 configured according to the embodiment of FIG. 3 is used. Oxygen and a fuel gas are supplied to the cutting torch 30. The oxygen pressure at the pressure reducer of the oxygen cylinder is set to 5 bar, which is the pressure established in the oxygen line 8 and which is the nominal oxygen pressure P_{O2}. The pressure at the pressure reducer of the acetylene cylinder is set to 0.7 bar. This is the nominal fuel gas pressure P_{H2}. A safety valve (demand valve; S.A.T valve) is inserted in the fuel gas line downstream of the pressure reducer. The safety valve is vacuum-controlled and it opens only when the negative pressure in the upstream fuel gas supply line has a set point of −0.3 bar or higher (more negative relative to atmospheric pressure).

Before inserting the cutting nozzle into the torch head, a pressure of 4.1 bar is present at the pressure nozzle. Due to the Venturi effect and the configuration of injector and mixing nozzle, a negative pressure of −0.44 bar compared to atmospheric pressure is established in the upstream fuel gas supply line (measured at the connection hose 5.2).

After inserting into the torch head a cutting nozzle for cutting metal sheets with a thicknesses of 10 to 100 mm, a pressure of 4.1 bar is still present at the pressure nozzle. Now, an effective negative pressure P_{negative} of −0.41 bar compared to atmospheric pressure is established in the upstream fuel gas supply line (measured at the connection hose 5.2). This effective negative pressure P_{negative} is present in the entire fuel gas line 7 up to the safety valve (except for a small decrease due to line resistance). Since this negative pressure (relative to atmospheric pressure) is at least equal or higher (more negative) than the set point of −0.3 bar, the safety valve opens, so that the cutting process can begin.

As a result of the comparatively high negative pressure, the fuel gas pressure can even be increased and additional fuel gas can be supplied to the cutting process. This allows a cutting process to be operated even with an excess of fuel gas, which can be useful for cutting particularly thick sheets, for example.

In the event of a leak in the upstream fuel gas supply line between the demand valve and the mixing nozzle inlet, the setpoint of −0.3 bar for the effective negative pressure cannot be reached because of the fuel gas escaping there, so that the demand valve does not open.

The large size of the diaphragm is particularly noticeable when the valve outlet opening dv is relatively small. This is because the greater the D_{M}/dᵥ ratio, the greater the flow rate of fuel gas can be for the same suction power. Or, to express it another way, by a higher ratio it is easier to set a fuel gas surplus in the fuel gas/oxygen mixture without the suction capacity dropping too far.

It will be appreciated by those skilled in the art that the invention is not limited to the precise details as described herein.

1. An oxy-fuel system for supplying a torch with a fuel gas stored under pressure in a container, said system comprising the following components:
(a) an upstream fuel gas supply line between the container and the torch;
(b) a demand valve arranged in the upstream fuel gas supply line;
(c) the torch connected to an oxygen supply line,
wherein the torch comprises a venturi nozzle adapted to generate in the upstream fuel gas supply line a negative pressure P_{negative} of at least −0.3 bar relative to atmospheric pressure in operating condition, and wherein the demand valve is vacuum-controlled and configured to have a pressure setpoint to open the demand valve, said pressure setpoint being negative relative to atmospheric pressure and equal or less negative than P_{negative}.

2. The oxy-fuel system of claim 1, wherein the pressure setpoint to open the demand valve is at least −2.5 bar, preferably at least −3 bar and most preferred at least −4 bar relative to atmospheric pressure.

3. The oxy-fuel system of claim 1, wherein the demand valve is a diaphragm valve (or membrane valve) comprising
(a) a valve body with a first port connected to the container, and a second port connected to the upstream fuel gas supply line,
(b) a diaphragm clamped in the valve body,
(c) a closure member coupled to the first side of the diaphragm and cooperating with a valve seat located between a valve inlet and a valve outlet, said closure member being adapted to open a passage between the valve inlet and the valve outlet when the pressure on the second side of the diaphragm is equal or higher (more negative relative to atmospheric pressure) than the pressure setpoint.

4. The oxy-fuel system according to claim 3, wherein the diaphragm has a circular cross-section with a diameter D_{M}, wherein D_{M} is greater than 50 mm, preferably greater than 52 mm, and particularly preferably greater than 54 mm.

5. The oxy-fuel system according to claim 4, wherein the valve seat forms a valve opening with an inner diameter dᵥ, and wherein the diameter ratio D_{M}/dᵥ is greater than 8.5, preferably greater than 8.8, and most preferred greater than 9.1.

6. The oxy-fuel system according to claim 1, wherein the torch is an injector torch, comprising a torch base body (24), a torch head (22) connected to the torch base body (24) and a torch tip (22.1) held therein, wherein flow paths are defined in the torch base body (24), at least one of which being a fuel gas supply line (8) extending from a fuel gas inlet (5.2), and at least one other being an oxygen path (9) extending from an oxygen inlet (5.1), and wherein the upstream fuel gas supply line (8) and at least a conduit portion of the oxygen supply line (9) join at a venturi nozzle (33; 33.1) to form a common outlet path (34) leading through the torch tip (22.1),
wherein the venturi nozzle comprises a pressure nozzle (33.5) fluidically connected to the oxygen supply line (9) and having a nozzle outlet (33.6),
wherein the outlet path comprises a mixing nozzle (34) and a mixing nozzle inlet (34.1) for generating an oxygen-fuel gas mixture,
and wherein the venturi nozzle (33; 33.1) and the mixing nozzle (34) are adapted to generate the negative pressure P_{negative} of at least −0.3 bar relative to atmospheric pressure in operating mode.

7. The oxy-fuel system according to claim 6, wherein the mixing nozzle inlet (34.1) has a diameter D, and wherein the nozzle outlet (33.6) of the pressure nozzle (33.5) has a diameter d, and that wherein for the diameter ratio d/D applies:
0.1<d/D<0.8, preferably 0.15<d/D<0.5, particularly preferably 0.2<d/D<0.4.

8. The oxy-fuel system according to claim 5, wherein the venturi nozzle comprises at least one injector insert (33.1) in which or on which is formed a fuel gas chamber (33.7) fluidically connected to the upstream fuel gas supply line (7) and adjacent to the mixing nozzle inlet (34.1), the nozzle outlet (33.6) of the pressure nozzle (33.5) being opposite the mixing nozzle inlet, and wherein between the nozzle outlet (33.6) of the pressure nozzle (33.5) and the mixing nozzle inlet (34.1) a distance A is set in the range between 0.2 mm and 2 mm, preferably between 0.25 mm and 1.5 mm and particularly preferably between 0.3 mm and 1.2 mm.

9. A method of operating an oxy-fuel system according to claim 1, comprising the method steps:
a fuel gas is supplied to the torch via an upstream fuel gas supply line with a nominal fuel gas pressure P_{H2} in the range of 0.5 to 2 bar,
oxygen is supplied to the torch via an oxygen line with an oxygen nominal pressure P_{O2} in the range of 2 to 10 bar,
the torch is provided with a venturi nozzle, which is designed so that an effective negative pressure P_{negative} of at least −0.3 bar relative to atmospheric pressure in operating condition is set in the fuel gas supply line,
wherein the demand valve is vacuum-controlled and configured to have a pressure setpoint to open the demand valve, wherein said pressure setpoint is negative relative to atmospheric pressure and equal or less negative than P_{negative}.

10. The method according to claim 9, wherein a negative pressure P_{negative} of at least −0.4 bar, preferably in the range from −0.4 to −0.8 bar, and particularly preferably in the range from −0.42 to −0.6 bar relative to atmospheric pressure is set in the upstream fuel gas supply line (7), and wherein the pressure setpoint to open the demand valve is at least −2.5 bar, preferably at least −3 bar and most preferred at least −4 bar relative to atmospheric pressure.

11. The method according to claim 9, wherein the fuel gas is acetylene, LPG, hydrogen, MPS, MAPP gas, propylene, butane or chemtane.

12. The method according to claim 9, wherein a fuel gas-oxygen mixture at or near the stoichiometric point, i.e., 35% acetylene and 65% oxygen or 82% oxygen and 18% LPG, or near other stoichiometric points is used.

13. The method according to claim 9, wherein a fuel gas-oxygen mixture with an overstoichiometric fuel gas content is used, preferably, the excess fuel gas is at least 5% higher than in the stoichiometric mixture, most preferred at least 9%.
